(19) United States
(12) Patent Application Publication
(10) Pub. No.: US 2016/0095284 A1
(43) Pub. Date: Apr. 7, 2016

(54) Expandable Plant Cover

(71) Applicant: Mark D. Britt, Chanute, KS (US)

(72) Inventor: Mark D. Britt, Chanute, KS (US)

(21) Appl. No.: 14/506,786

(22) Filed: Oct. 6, 2014

(51) Int. Cl. A01G 13/04; B31B 17/60

(52) U.S. Cl. CPC A01G 13/04; B31B 17/60

(57) ABSTRACT

A plurality of similar components for forming a plant covering device for the protection of plants from external adverse weather elements and other hazards. The components are made of a thin sheet of flexible plastic or other material cut into similar two-dimensional component panels allowing many different configurations to be made out of the plurality of components. The individual component panels are provided with a fastening means for joining the separate component panels into a completed assembly. The plant covering device provides an easily assembled, self-supporting structure to be placed over one or more plants or a location. The plant covering device is erected without the use of tools or need for a separate frame or support. The size of the plant covering device may be reconfigured and expanded in width, and/or height, and/or depth using an additional plurality of component panels. The plant covering device may be used with stakes or spikes. The plant covering device may be disassembled to a planar configuration. The plant covering device may be easily and inexpensively manufactured. The plant covering device may be repeatedly used from season to season. A portion of the sides of an assembled plant covering device may be easily and quickly opened or closed such as by manual manipulation. Alignment areas along the base of a plant covering device provide for increased contact with the ground, resilience against wind, and use with stakes or spikes. The plant covering device may be assembled from a plurality of components into a three-dimensional rectangular shape and placed in a desired location. A preferred form is a three-dimensional rectangular shape.

### CROSS-REFERENCE TO RELATED APPLICATIONS

Not Applicable

### STATEMENT REGARDING FEDERALLY SPONSORED RESEARCH OR DEVELOPEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates generally to systems, devices and methods for forming a self-supporting plant covering device for protecting plants from adverse weather elements. The invention contains a plurality of similar component panels made of plastic or other material for assembly into many different configurations.

2. Description of the Related Art

Plants are at risk from a variety of adverse weather elements and other hazards, cold weather in the spring or fall bringing frost, snow or hail, damage from wind and heavy rains, and damage due to small animals or insects feeding off the plants. An effective means of protecting plants is to isolate them from these adverse elements by covering them with a structure which allows light in and water to be added while reducing the risk of damage from pests and adverse weather elements. It is also advantageous if this structure is quickly and easily setup or built, is economical for the home gardener, and provides protection to plants of a various sizes and stages of growth.

Presently few prior art devices address all of these problems. For example, current devices include greenhouses, hoop arrangements covered in plastic film and like materials, and self-supporting devices made of plastic and other materials.

Greenhouses are generally large, expensive and permanent, can be complicated to assemble, generally require internal support structure, generally impractical or cumbersome disassemble and store, and may present a risk to the plant during transplanting. Mini-greenhouses may require little or no assembly or disassembly, may be somewhat less expensive, however they generally suffer similar deficiencies as the larger greenhouses, and they only provide a small limited space for plants.

Hoop arrangement devices which are erected over a garden area and which are covered with a transparent or semi-transparent plastic film, garden fabric, and other material are difficult to setup, difficult to move, are generally expensive, and although smaller arrangements are less expensive they make it difficult to water the plants by hand and are cumbersome to access individual plants for picking fruit and vegetables and perform other maintenance.

Various types of plastic devices have also been used. One type of device utilizes water-filled pockets of plastic material. This type of cover is relatively heavy and presents a risk to the plant if handled improperly and narrows at the top when closed decreasing the space available for the plant to grow and expand.

Other types of plastic devices also narrow at the top. Many plants need more space near the top than at the bottom, such as some Tomato plants and pepper plants.

In addition, hoop arrangement and plastic devices have generally fixed dimensions making it impossible or difficult to add to or adjust them in width, height, and length as plants grow and require more space. This shortcoming and others are overcome through the use of the current invention.

### BRIEF SUMMARY OF THE INVENTION

The present invention provides an improved plant covering device which is easily assembled, easily configured and reconfigured in form, and has a self-supporting structure to be placed over individual plants, groups of plants or location.

The plant covering device provides protection for plants from adverse weather elements and other hazards such as frost, snow, hail, heavy rain, wind and damage caused by small animals and insects, is easily and quickly assembled by hand without the use of tools, may be assembled such as by manual manipulation from planer form without other materials or need for frame or support, and may be used with stakes or spikes to increase wind resistance and reduce risk of damage from tipping over or lateral movement.

According to one aspect of the invention there is provided a plurality of similar individual component panels for forming a plant covering device of the type for enclosing a space and isolating said space from external adverse elements, said component panels made from a flexible thin sheet of plastic or other material for assembly into a structure wherein the individual component panels are provided with fastening means for joining separate component panels into a completed assembly, said assembly having a top, sides, and a bottom edge, the bottom edge for resting on a supporting surface, and wherein the bottom edge has one or more apertures for mounting a removable stake and holding the completed assembly on the supporting surface.

The component panels may be disassembled to a planar configuration quickly and easily. One or more component panels may be stored in a minimum of space.

The component panels comprise a material that both acts as a thermal insulator, yet limits, from substantially none to substantially all, the transmission of solar radiation into the interior space. When incident and ambient light and/or radiation pass through the component panel, heat is retained in the interior space, plant(s) and ground or support surface.

The invention is designed for use in spring, summer, and autumn to maximize each growing season.

A portion of the fastening means of the invention may be easily disassembled to permit watering to the interior of the invention then easily reassembled.

The invention may be easily and inexpensively manufactured. The invention may be repeatedly used, stored, and reused year to year.

Optionally, the invention comprises a method of assembly that, for example, may be engaged to create an opening to the interior of the invention wherein said opening provides for ventilation.

The component panels may be manufactured in a wide variety of sizes and colors without substantially altering its protective or configurable features.

In short, described herein is an improved plant covering device comprised of a plurality of individual component panels. The component panels made from a flexible or bendable material that is cut or formed into a substantially rectangular two-dimensional blank or shape. The plant covering device may be assembled from a plurality of blanks into a generally symmetrical three-dimensional rectangular shape and installed or placed in a location. The plant covering device may be assembled into different configurations including variations in width, and/or height, and/or length using a plurality of component panels. The general form is a three-dimensional rectangular shape.

This Summary has introduced a non-exclusive selection of aspects or concepts about the present invention in a simplified form that are further described in the Detailed Description. This Summary is not intended to identify key or essential features of the claimed subject matter, and is not intended to be used to limit the scope of the claimed subject matter.

### BRIEF DESCRIPTION OF THE DRAWINGS

The novel features believed characteristic of the subject matter are set forth in the appended claims. Throughout, like numerals refer to like parts with the first digit of each numeral generally referring to the figure which first illustrates the particular part. The subject matter and a preferred mode of use are best understood by reference to the Detailed Description of illustrative implementations when read in conjunction with the accompanying drawings, wherein:

FIG. 1 is an overhead view of a two dimensional component panel formed from a sheet of material according to an exemplary implementation of the invention;

FIG. 2 is a perspective oblique overhead view showing one possible configuration of one plant covering device comprising a plurality of component panels shown in FIG. 1 and partially assembled;

FIG. 3A is a perspective oblique overhead view of the plant covering device shown in FIG. 2 and fully assembled according to an exemplary implementation of the invention;

FIG. 3B is a front view of an engaged assembly tab of the plant covering device shown in FIG. 3A;

FIG. 4 is a perspective side view of the plant covering device shown in FIG. 3A, fully assembled including optional assembly to provide for ventilation, and placed to provide protection to a plant;

FIG. 5 is a perspective oblique side view of the plant covering device shown in FIG. 3A, reconfigured to be expanded in height and fully assembled;

FIG. 6 is a perspective oblique side view of the plant covering device shown in FIG. 3A, reconfigured to be expanded in width and fully assembled; and

FIG. 7 is a perspective oblique side view of a plant covering device shown in FIG. 3A, reconfigured to be expanded in width, height and length, and partially assembled.

### DETAILED DESCRIPTION OF THE INVENTION

In view of the current state of plant covering devices as described in the Background, there is a need for an improved plant covering device. Described herein are systems, devices and methods for creating, forming, providing, assembling and installing an improved plant covering device.

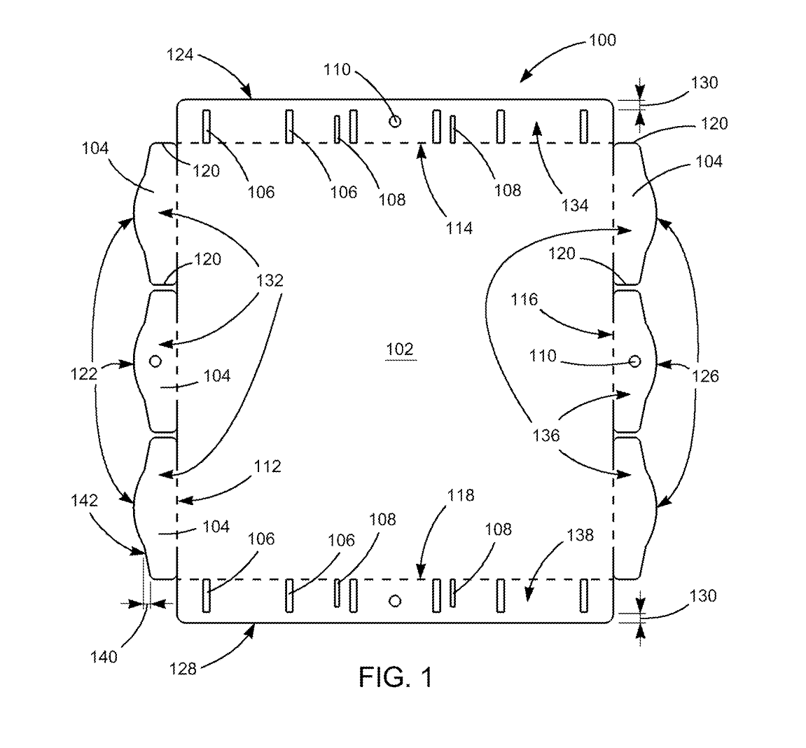

FIG. 1 is an overhead view of an individual component panel 100 in an unassembled state. The component panel 100 is preferably formed from a sheet of transparent or semitransparent material 102 according to an exemplary implementation of the invention such that a plurality of different configurations can be assembled from the same plurality of component panels 100. With reference to FIG. 1, a component panel 100 comprises several features. Along a first lateral edge 122 and along a second lateral edge 126 of the component panel 100 each having one or more assembly tabs 104 formed at or near one or more places. Each assembly tab 104 comprises one or more fingers, protuberances, extensions, or tab members 120. A tab member 120 comprises one or more tapered edges 142. A width variation 140 of a tab member 120 as measured at the top end of a tapered edge 142 and as measured at the bottom end of the tapered edge 142 is selected based on one or more factors. These factors may include a composition or characteristic of the sheet of material 102 (e.g., rigidness, thickness, bend-ability or effort needed to bend the sheet of material 102); a size, width or height of a reduced size assembly slot 108, tab member 120 or assembly tab 104; position of an assembly tab 104 along the first lateral edge 122 or along the second lateral edge 126; and position of a reduced size assembly slot 108 along a third lateral edge 124 or along a fourth lateral edge 128. A tab member 120 may be extended through an assembly slot 106. Along the third lateral edge 124 and along the fourth lateral edge 128 of a component panel 100 each having one or more assembly slots 106 formed a spacing distance 130 at one or more places. There may be one or more assembly slots 106 for each assembly tab 104 or tab member 120. The spacing distance 130 as measured at any given location along the third lateral edge 124 or along the fourth lateral edge 128 of a component panel 100 is selected based on one or more factors. These factors may include a composition or characteristic of the sheet of material 102 (e.g., rigidness, thickness, bend-ability or effort needed to bend the sheet of material 102); a size, width or height of tab member 120 or assembly tab 104; and position of assembly tab 104 along the first lateral edge 122 or along the second lateral edge 126 of a panel 100.

A component panel 100 also comprises one or more reduced size assembly slots 108 along the third lateral edge 124 and along the fourth lateral edge 128. A reduced size assembly slot 108 is reduced in size (e.g., width and/or height and/or thickness) to allow partial insertion of an assembly tab member 120 of an assembly tab 104 into the reduced size assembly slot 108 to facilitate ventilation.

A component panel 100 also comprises a crease pattern. With reference to FIG. 1, an exemplary crease pattern comprises a bend line 112 delineating an alignment area 132 therein encompassing all of at least one or more assembly tabs 104 along the first lateral edge 122, a bend line 116 delineating an alignment area 136 therein encompassing all of at least one or more assembly tabs 104 along the second lateral edge 126, a bend line 114 delineating an alignment area 134 therein encompassing all of at least one or more assembly slots 106 along the third lateral edge 124, and a bend line 118 delineating an alignment area 138 therein encompassing all of at least one or more assembly slots 106 along the fourth lateral edge 128 each bendable to at least a substantially forty-five degree angle or more facilitating assembly of a plurality of component panels 100.

A component panel 100 preferably further comprises at least one or more apertures 110. In a preferred implementation, and as shown in FIG. 1, each aperture 110 is positioned near the center of each of at least one or more of alignment area 132, and/or alignment area 136, and/or alignment area 134 and/or alignment area 138 for receiving or attaching a stake, spike, peg or other entity.

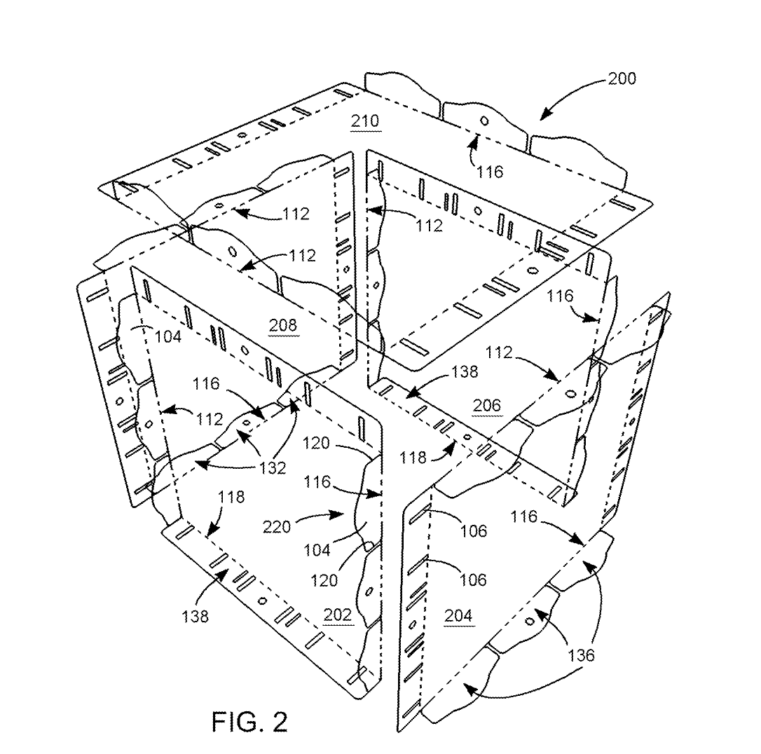

FIG. 2 is a perspective oblique overhead view of a plant covering device 200. The plant covering device 200 is a partially assembled plurality of component panels 100 each shown in FIG. 1. With reference to FIG. 2, in a preferred implementation, and to facilitate assembly, component panel 202, component panel 204, component panel 206, component panel 208 and component panel 210 each bent outwardly with respect to its plane each along bend line 112 and along bend line 116 each located on the opposite side of each said component panel each to a substantially ninety degree angle wherein also providing increased structural support by increasing rigidity along each bend line 112 and along each bend line 116. Component panel 202 and component panel 206 each is bent outwardly with respect to its plane each along bend line 118 to a substantially ninety degree angle wherein providing increased structural support by increasing rigidity along each bend line 118. Component panel 202, component panel 204, component panel 206 and component panel 208 each is positioned vertically to a horizontal surface. Component panel 210 is positioned horizontal to the horizontal surface. Component panel 204, component panel 208 and component panel 210 each is rotated clock-wise with respect to its plane to substantially ninety degrees. The left side of component panel 204 with respect to its rotation is positioned adjacent and perpendicular to the right side of component panel 202. The left side of component panel 206 with respect to its rotation is positioned adjacent and perpendicular to the right side of component panel 204. The left side of component panel 208 is positioned adjacent and perpendicular to the right side of component panel 206. The bottom side of component panel 210 with respect to its rotation is positioned above and adjacent to the top side of component panel 202. A first engaged assembly tab 220 of component panel 202 is reversibly attached to adjacent component panel 204. Two of the tab members 120 of assembly tab 220 of component panel 202 have been inserted through respective assembly slots 106 of adjacent component panel 204. One method of assembling an assembly tab 104 is to manually bend an opposing pair of tab members 120 approximately ninety degrees to a near perpendicular orientation relative to the body of the assembly tab 104 and insert each of the tab members 120 through a respective adjacent assembly slot 106. A pair of tab members 120 may be quickly and easily inserted in a pair of slots 106. The method may be repeated as needed to assemble each of the assembly tabs 104 for each of component panel 202, component panel 204, component panel 206, component panel 208 and component panel 210 of the plant covering device 200 each with at least one or more of said component panels each with corresponding assembly slots 106 thereby forming and assembling the plant covering device 200 into a three-dimensional rectangular shape.

In the implementation shown in FIG. 2, tab member 120 and slot 106 are designed to be engaged in one another. Slot 106 is an exemplary closure mechanism for tab member 120. Other closure mechanisms may be used including snaps, loops, hooks, tab and slot arrangements, hook and loop fasteners and adhesive. Slot 106 and tab member 120 shown in FIG. 2 are preferable at least because they can be inexpensively manufactured.

With reference to FIG. 2, each of alignment area 132 and/or alignment area 136 and/or alignment area 138 of each component panel 100 shown in FIG. 1 along the base of a plant covering device 200 when fully assembled form a substantially even plane and provide lateral support to the plant covering device 200, allowing the plant covering device 200 to resist lateral forces when in place on a surface or over a plant, and also provides lateral stability so as to reduce the risk that the plant covering device 200 tips over and partially or fully exposes the plant and space beneath it. An exposed plant is then exposed to ambient weather and temperatures.

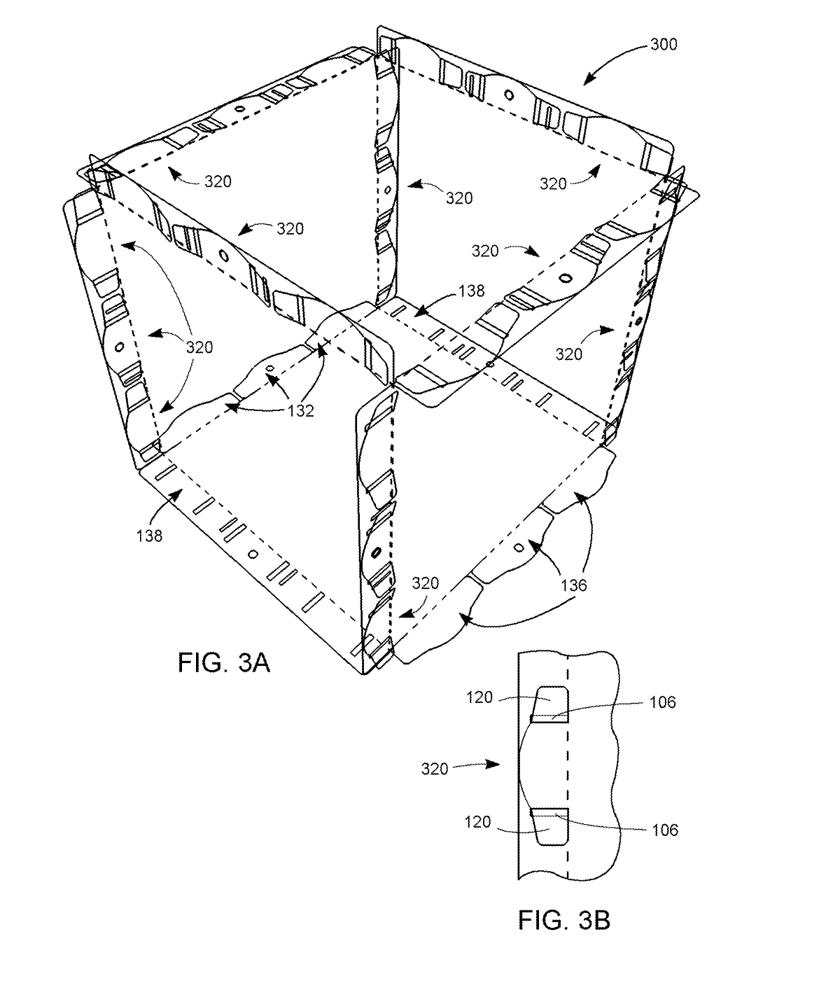

FIG. 3A is a perspective oblique overhead view of plant covering device 300 shown in FIG. 2 and fully assembled according to an exemplary implementation of the invention. With reference to FIG. 3A, a plant covering device 300 has been fully assembled into a three-dimensional rectangular shape; each of the engaged assembly tabs 320 maintain the plant covering device 300 in a closed state; each of alignment area 132, alignment area 136, and each alignment area 138 as assembled form the bottom edge of plant covering device 300; and the bottom edge rests on a supporting surface.

FIG. 3B is a front view of an engaged assembly tab 320 of plant covering device 300 shown in FIG. 3A. With reference to FIG. 3B, each one of two tab members 120 of engaged assembly tab 320 is inserted through and interlocked with a corresponding assembly slot 106.

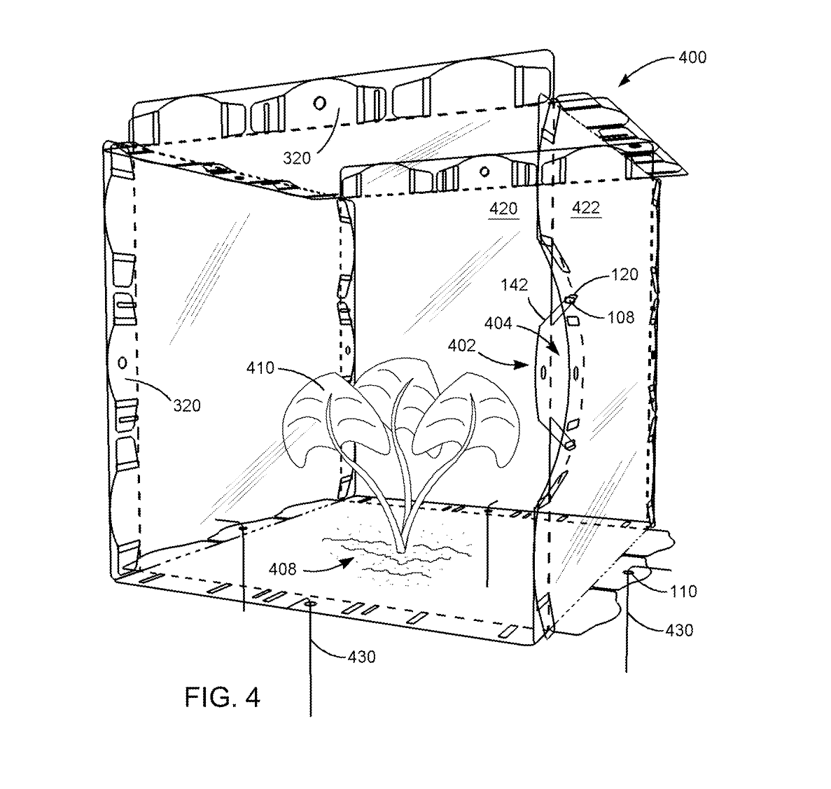

FIG. 4 is a perspective side view of the plant covering device 400 shown in FIG.3A, fully assembled, includes optional assembly providing for ventilation, and placed to provide protection to a plant 410. With reference to FIG. 4, a plant covering device 400 has been fully assembled including an optional method of assembly, for example, wherein each of the at least one tab member 120 of assembly tab 402 of component panel 420 is reversibly at least partially engaged wherein engagement is limited by a tapered edge 142 with a reduced sized assembly slot 108 of adjacent component panel 422 thereby outwardly deforming component panel 422 and exposing a curvilinear opening 404 between component panel 420 and adjacent component panel 422 to facilitate ventilation into the interior space of the assembled plant covering device 400. To facilitate additional ventilation and reduce the opportunity for over-heating the interior of the assembled plant covering device 400, for example, the optional method of assembly may be repeated for each of one or more engaged assembly tabs 320. In a preferred method of installation, the ground or place of installation 408 should be at least moderately firmed prior to installing an assembled plant covering device 400 to avoid tipping and/or lateral movement. After firming the ground 408, an assembled plant covering device 400 is placed over one or more plants 410. Optionally, a stake, spike, peg, rod or other implement 430 may be placed in one or more apertures 110 along the base of the assembled plant covering device 400. The addition of one or more stakes 430 usually prevents the assembled plant covering device 400 from tipping over even in wind.

Once installed, the assembled plant covering device 400 can provide several forms of protection and several benefits. For example, the assembled plant covering device 400 provide protection against wind damage. Further, the assembled plant covering device 400 acts as a mini-greenhouse boosting the temperature around the plant or plants 410. This is especially advantageous in the spring and fall. Increased temperature in the interior of the assembled plant covering device 400 during the cool temperatures in early spring and fall help extend the growing season by providing temperatures that help a plant or plants 410 grow more during each season and thus can help yield more produce. The assembled plant covering device 400 also helps reduce or eliminate damage from frost, hail and heavy rain.

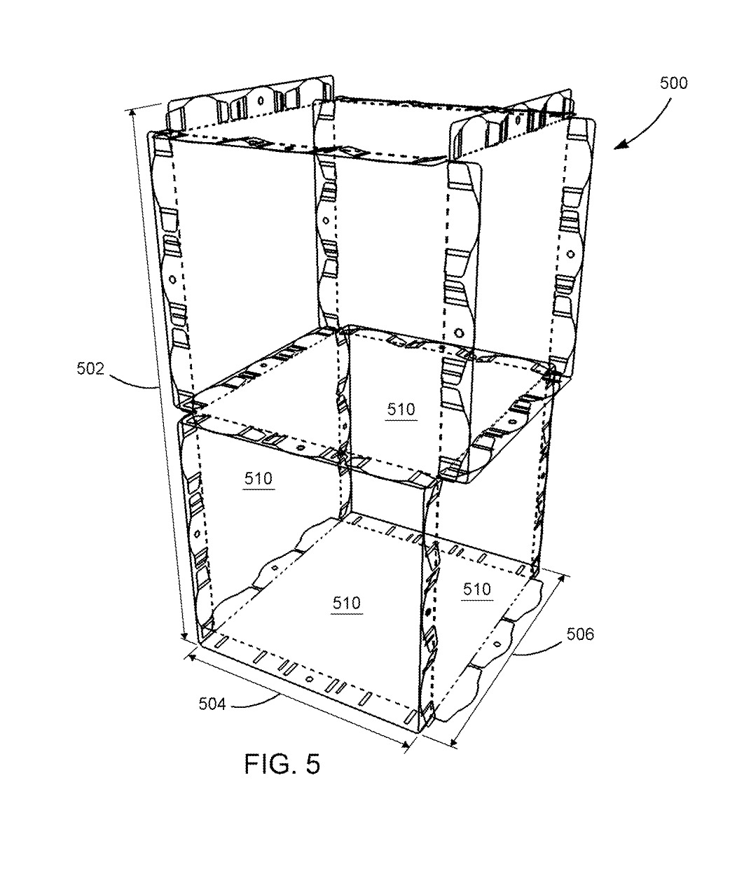

FIG. 5 is a perspective oblique side view of the plant covering device 500 shown in FIG. 3A, configured to show an alternate configuration of the invention expanded in height and fully assembled according to another exemplary implementation of the invention. With reference to FIG. 5, a plant covering device 500 is expanded in height by assembling an additional plurality of component panels 510. The configuration of the assembled plant covering device 500 is two collateral assembled component panels 100 shown in FIG. 1 in height 502, one assembled component panel 100 in width 504, and one assembled component panel 100 in length 506.

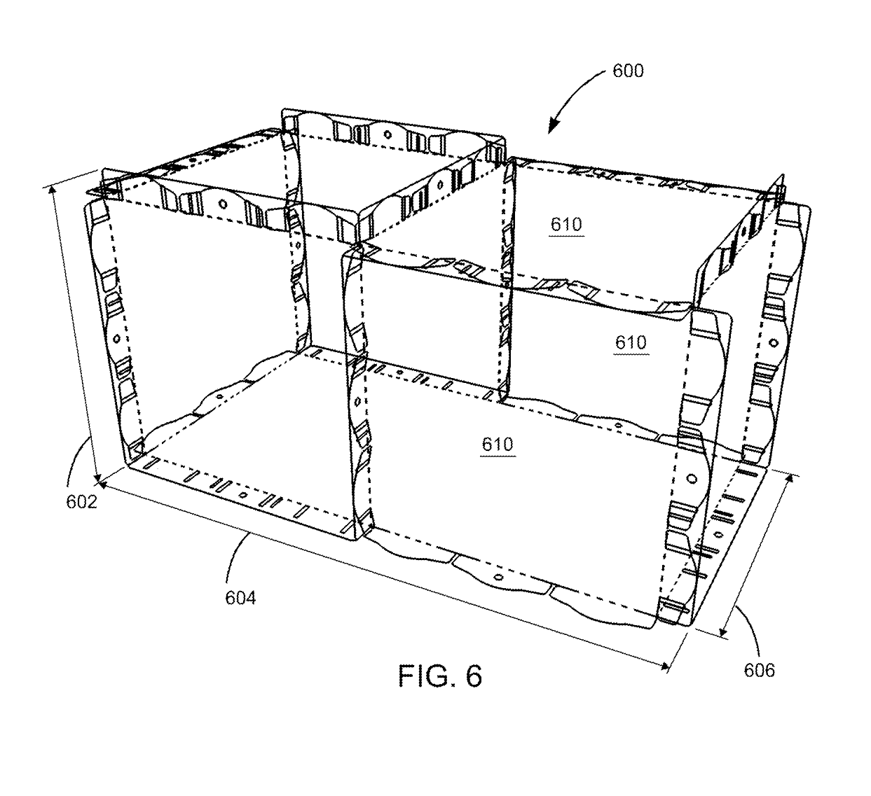

FIG. 6 is a perspective oblique side view of the plant covering device 600 shown in FIG. 3A, configured to show an alternate configuration of the invention expanded in width and fully assembled according to another exemplary implementation of the invention. With reference to FIG. 6, a plant covering device 600 is expanded in width by assembling an additional plurality of component panels 610. The configuration of the assembled plant covering device 600 is one assembled component panel 100 shown in FIG. 1 in height 602, two collateral assembled component panels 100 in width 604 and one assembled component panel 100 in length 606.

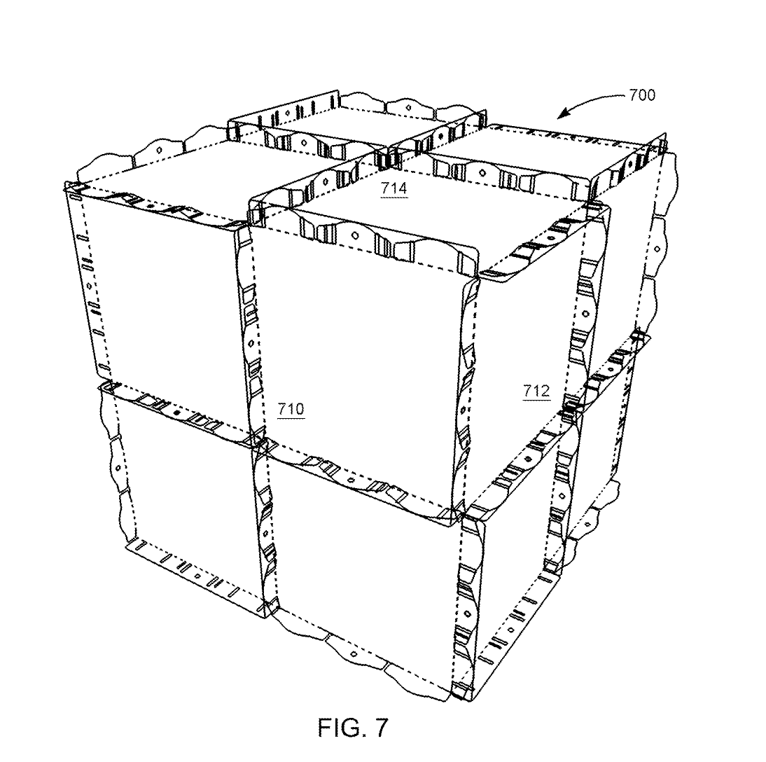

FIG. 7 is a perspective oblique side view of plant covering device 700 shown in FIG. 3A configured to show an alternate configuration of the invention expanded in width, height and length by assembling an additional plurality of panels 100 shown in FIG. 1, and partially assembled according to another exemplary implementation of the invention. With reference to FIG. 7, a plant covering device 700 has been partially assembled showing a planar side one 710, planar side two 712 and a planar top 714 each comprising four assembled component panels 100 shown in FIG. 1 each assembled adjacent and parallel to one another forming generally a square rectangle wherein each planar side and planar top assembled adjacent and perpendicular to one another.

### Variations

While the invention is described with respect to one or more exemplary and preferred implementations, other implementations are possible. The concepts disclosed herein apply equally to other systems, devices and methods for covering and protecting plants. The invention is described with reference to the accompanying figures where it is noted that characteristics and features shown in the figures are not drawn to scale unless otherwise noted herein.

It will be understood that terms used herein, including in the claims, are generally intended as “open” terms (e.g., the term “including” should be interpreted as “including but not limited to”, the term “having” should be interpreted as “includes but is not limited to”). It will be further understood by those within the art that if a specific number of an introduced claim recitation is intended, such an intent will be explicitly recited in the claim, and in the absence of such recitation no such intent is present.

For example, as aid to understanding, the following claims may contain usage of the introductory phrases “at least one” and “one or more” to introduce claim recitations. The use of such phrases should not be construed to imply that the introduction of a claim recitation by the indefinite articles “a” or “an” limits any particular claim containing such introduced claim recitation to inventions containing only one such recitation, even when the same claim includes the introductory phrases “at least one” or “one or more” and indefinite articles such as “a” or “an” (e.g., “a” and “an” should typically be interpreted to mean “at least one” or “one or more”). The same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations”, without other modifiers, typically means at least two recitations, or two or more recitations).

Furthermore, in those instances where a convention analogous to “at least one of A, B, and C”, is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”. Moreover, “can”, “may” and “optionally” and other permissive terms are used herein for describing optional features of various embodiments. These terms likewise describe selectable or configurable features generally, unless the context dictates otherwise.

The described aspects of the invention depict different components contained within, or connected with, different other components, It is to be understood that such depicted elements are merely exemplary, and that in fact many other elements can be implemented which achieve the same functionality. Further, it is to be understood that one of ordinary skill in the art as to the invention described herein is someone familiar with plants and crops.

The foregoing discussion has been presented for purposes of illustration and description. Various features from one implementation can be combined with other features from other implementations. The description is not intended to limit the invention to the form or forms disclosed herein. Consequently, variation and modification commensurate with the above teachings, within the skill and knowledge of the relevant art, are within the scope of the present invention. The implementations described herein and above are also intended to explain the best mode presently known of practicing the invention and to enable others skilled in the art to use the invention, or in other implementations, and with the various modifications required by their particular application or uses of the invention. It is intended that the appended claims be construed to include alternate implementations to the extent permitted. Thus, the appended claims are to encompass within their scope all variations and modifications as are within the spirit and scope of this subject matter described herein.

I claim:

1. An assembly for forming a plant covering device of the type for enclosing a space and isolating said space from external adverse weather elements, said assembly comprising:
a plurality of similar individual component panels for assembly into a structure having a top and sides enclosing the space within and a bottom edge for resting on a supporting surface;
each individual component panel when assembled into a generally symmetrical rectangular three-dimensional shape are in adjacent relationship;
fastening means for releasably joining individual adjacent component panels one to the other into the completed assembly wherein said fastening means comprises at least one or more assembly tabs and/or at least one or more assembly slots formed along each one of the four edges of each one of the respective individual component panels;
each component panel made from a flexible sheet of material of a generally rectangular shape wherein said fastening means formed along each one of the four edges of each one of the respective individual component panels;
each component panel further comprising a crease pattern along which an individual component panel is bendable to at least a substantially forty-five degree angle and wherein defining an alignment area along each edge of each said component panel for facilitating assembly, wherein the crease pattern is sufficiently made of lines made of a solid line, dots, dashes, imaginary line, other marks or cuts, or any other combination thereof; and
each component panel when assembled generally positioned adjacent and parallel or adjacent and perpendicular to at least one or more adjacent component panels wherein an alignment area of each one or more said adjacent component panels is generally positioned back-to-back with a corresponding adjacent alignment area of said component panel wherein each said alignment area is sufficiently bent along a portion of the crease pattern of the component panel providing for alignment of said alignment areas.

2. An assembly according to claim 1 wherein said fastening means of each component panel so arranged that each assembly tab at least partially and releasably interlocks with at least one corresponding assembly slot of an adjacent component panel when assembled wherein the at least one corresponding assembly slot is spaced in from the edge of the adjacent component panel.

3. An assembly according to claim 2 wherein at least one or more assembly tabs formed along the left edge, at least one or more assembly tabs formed along the right edge, at least one or more assembly slots formed along the top edge and at least one or more assembly slots formed along the bottom edge of each component panel.

4. An assembly according to claim 2 wherein each of the at least one or more assembly tabs wherein said assembly tabs formed along an edge of a component panel includes at least two tab members, and wherein an adjacent component panel comprises two corresponding assembly slots for each tab member of each said assembly tab, and wherein the corresponding assembly slots are arranged in pairs along the adjacent edge of the adjacent component panel.

5. An assembly according to claim 4 wherein at least one component panel further comprises at least one reduced assembly slot positioned near an assembly slot, wherein the reduced assembly slot is reduced in size in width and/or height to partially limit engaging with a corresponding tab member of an assembly tab of an adjacent component panel, wherein the tab member is tapered along at least one edge, wherein engaging the tab member with the reduced assembly slot is limited by the tapered width and/or height of the tab member and further limited by the size of the reduced assembly slot, wherein when engaging forming a temporary curvilinear opening between the component panel and the adjacent component panel thereby facilitating ventilation.

6. An assembly according to claim 1 wherein different configurations can be formed from a plurality of component panels.

7. An assembly according to claim 1 wherein at least one or more of the plurality of component panels is transparent or semitransparent.

8. An assembly according to claim 1 wherein a component panel is made from polyethylene terephthalate.

9. An assembly according to claim 1 wherein said crease pattern of each said component panel comprises:
a first bend line extending transversely across a component panel, wherein the first bend line is substantially parallel to the left edge of the component panel defining a first alignment area, wherein the first alignment area is at least encompassing said fastening means along the left edge of the component panel, and wherein the first alignment area is substantially extending between the top edge and the bottom edge of the component panel;
a second bend line extending transversely across a component panel, wherein the second bend line is substantially parallel to the right edge of the component panel defining a second alignment area, wherein the second alignment area is at least encompassing said fastening means along the right edge of the component panel, and wherein the second alignment area is substantially extending between the top edge and the bottom edge of the component panel;
a third bend line extending transversely across a component panel, wherein the third bend line is substantially parallel to the top edge of the component panel defining a third alignment area, wherein the third alignment area is at least encompassing said fastening means along the top edge of the component panel, and wherein the third alignment area is substantially extending between the left edge and the right edge of the component panel;
a fourth bend line extending transversely across a component panel, wherein the fourth bend line is substantially parallel to the bottom edge of the component panel defining a fourth alignment area, wherein the fourth alignment area is at least encompassing said fastening means along the bottom edge of the component panel, and wherein the fourth alignment area is substantially extending between the left edge and the right edge of the component panel.

10. An assembly according to claim 1 wherein the assembly further comprises at least one stake removably mounted through a respective aperture positioned within an alignment area along the base of at least one or more of the plurality of component panels assembled along the bottom edge of the assembly when assembled.

11. A method for assembling an assembly made from a plurality of at least five component panels, the method comprising:
with respect to the first and third component panels each bending the first alignment area outwardly along the first bend line to a substantially ninety degree angle, bending the second alignment area outwardly along the second bend line to a substantially ninety degree angle, and bending the fourth alignment area outwardly along the fourth bend line to a substantially ninety degree angle;
with respect to the second, fourth and fifth component panels each bending the first alignment area outwardly along the first bend line to a substantially ninety degree angle, and bending the second alignment area outwardly along the second bend line to a substantially ninety degree angle;
positioning the first and second component panels generally vertically, aligning the second alignment area of the first component panel back-to-back with the fourth alignment area of the second component panel wherein the plane of the second component panel is generally perpendicular to the plane of the first component panel and wherein the second component panel is rotated clockwise by substantially ninety degrees and engaging each one or more assembly tabs of both said alignment areas with at least one or more corresponding assembly slots of an adjacent said alignment area;
positioning the third component panel generally vertically, aligning the first alignment area of the third component panel back-to-back with the third alignment area of the second component panel wherein the plane of the third component panel is generally perpendicular to the plane of the second component panel and engaging each one or more assembly tabs of both said alignment areas with at least one or more corresponding assembly slots of an adjacent said alignment area;
positioning the fourth component panel generally vertically, aligning the fourth alignment area of the fourth component panel back-to-back with the second alignment area of the third component panel wherein the plane of the fourth component panel is generally perpendicular to the plane of the third component panel and wherein the fourth component panel is rotated clockwise by substantially ninety degrees and engaging each one or more assembly tabs of both said alignment areas with at least one or more corresponding assembly slots of an adjacent said alignment area;
aligning the third alignment area of the fourth component panel back-to-back with the first alignment area of the first component panel wherein the plane of the first component panel is generally perpendicular to the plane of the fourth component panel and engaging each one or more assembly tabs of both said alignment areas with at least one or more corresponding assembly slots of an adjacent said alignment area;
positioning the fifth component panel generally horizontally wherein the fifth component panel is rotated clockwise by substantially ninety degrees, aligning the second alignment area of the fifth component panel back-to-back with the third alignment area of the first component panel and engaging each one or more assembly tabs of both said alignment areas with at least one or more corresponding assembly slots of an adjacent said alignment area;
aligning the first alignment area of the fifth component panel back-to-back with the third alignment area of the third component panel and engaging each one or more assembly tabs of both said alignment areas with at least one or more corresponding assembly slots of an adjacent said alignment area;
aligning the third alignment area of the fifth component panel back-to-back with the first alignment area of the second component panel and engaging each one or more assembly tabs of both said alignment areas with at least one or more corresponding assembly slots of an adjacent said alignment area;
aligning the fourth alignment area of the fifth component panel back-to-back with the first alignment area of the fourth component panel and engaging each one or more assembly tabs of both said alignment areas with at least one or more corresponding assembly slots of an adjacent said alignment area thereby assembling the complete assembly.

12. The method of claim 7, the method further comprises:
engaging at least one stake with at least one aperture along the base of at least one or more component panels forming the bottom edge of the assembly when installing the assembly.

13. The method of claim 7, the method further comprises:
engaging each of at least one or more tab members of the at least one or more assembly tabs of at least one or more of the plurality of component panels with a corresponding reduced assembly slot of an adjacent component panel when assembling the assembly thereby facilitating ventilation.
